(19) United States
(12) Patent Application Publication
(10) Pub. No.: US 2002/0097974 A1
(43) Pub. Date: Jul. 25, 2002

(54) Optical fiber array and method of fabrication thereof

(75) Inventors: Akira Matsumoto, Nagoya-shi (JP); Masashi Fukuyama, Inuyama-shi (JP)

Correspondence Address: BURR & BROWN, PO BOX 7068, SYRACUSE, NY, 13261-7068, US

(73) Assignee: NGK Insulators, Ltd., Nagoya (JP)

(21) Appl. No.: 09/946,147

(22) Filed: Sep. 4, 2001

(30) Foreign Application Priority Data
Sep. 4, 2000 (JP) 2000-267495
Aug. 30, 2001 (JP) PCT/JP01/07482

(51) Int. Cl. G02B 6/00; G02B 6/36

(52) U.S. Cl. 385/137; 385/80; 385/83

(57) ABSTRACT

An optical fiber array is presented, in which the adherence of a lower substrate to an upper substrate is good, and no stress concentrations occur in the optical fibers. In a lower substrate 2, V-grooves 3 are formed that have an inscribed circle A that is formed between the V-grooves and the virtual plane of the upper surface of the lower substrate, and which is larger than the optical fibers 1 that are accommodated in the V-grooves 3. A UV curing adhesive 5 of a 2000 cp viscosity is filled into the V-grooves 3, and the optical fibers 1 are arranged within the V-grooves 3. Next, a predetermined amount of UV rays are irradiated on the adhesive 5 to raise its viscosity to at least 3000 cp, after which an upper substrate 4 is arranged on the optical fibers 1 and pressure adhered, and UV rays are irradiated a again to completely cure the adhesive 5.

### TECHNICAL FIELD

The present invention relates to an optical fiber array formed by fixing a plurality of optical fibers in a line with a lower substrate and an upper substrate, and in particular, an optical fiber array with good adherence between the lower substrate and upper substrate and in which no stress concentrations occur in the optical fibers, as well as a simple method for fabricating the same.

### BACKGROUND ART

A conventional optical fiber array in which a plurality of optical fibers is fixed in a line is configured as shown in FIG. 5. FIG. 5 is a magnified front view, and as shown in this diagram, optical fibers 12 normally abut against a plurality of V grooves 11 that are formed at equal spacing in a lower substrate 13. Thus, the precision of the optical fiber array is secured at the two points of contact, reflecting the precision of the V-grooves. An upper substrate 14 covers the top of the lower substrate 13 and the optical fibers 12, and an adhesive is filled therebetween to fasten the three and fix the optical fibers 12 in a line.

Moreover, the polarization maintaining fibers, which are one type of optical fiber, are affected by pressure from the outside, so when the fibers are held by a support, for example, a holding structure is necessary not to exert local pressure. For this reason, structures such as the one disclosed in Japanese Patent Publication No. 5-264843A have been adopted. As shown in the schematic cross-sectional view of FIG. 7, the diameter A of an inscribed circle formed between the V-grooves 11 and the virtual plane joining the upper surface of the lower substrate is formed to be equal to or greater than that of the polarization maintaining fibers 15 in this structure. As a result, the polarization maintaining fibers 15 are housed in the V grooves 11.

In FIG. 7, the polarization maintaining fibers 15 are arranged in the V grooves 11 that are formed in the lower substrate 13, and are immovably fixed by an adhesive 16 filed in between the upper substrate 14 and the lower substrate 13. The V-grooves 11 are formed to a depth at which the polarization maintaining fibers 15 arranged therein do not protrude above the surface of the substrate. The polarization maintaining fibers 15 are fixed in a predetermined position in which they do not directly abut against the V-grooves, and an adhesive is disposed around the fibers so that stress concentrations do not occur. Planar portions 13a and 14a, which are provided at the left and right ends of the optical fiber maintaining portions formed by the plurality of V-grooves 11, serve as adhesive surfaces for adhering the lower substrate 13 to the upper substrate 14.

If, however, the optical fibers are arranged making contact at two points as shown in FIG. 5 above, the optical fibers come into contact with the V-grooves. Thus, stress concentrations occur at the rear end portion of the V-grooves on the optical fiber insertion side, that is, near the M portion shown in the lateral view of the optical fiber array in FIG. 6. Thus, there are concerns that long-term reliability will be negatively affected, such as concerns over fiber disconnections caused by damage to the optical fiber. Furthermore, in the case of FIG. 5 in which there are two contact points, there is hardly any layer of adhesive 16 at the contacting portions of the optical fibers 12 and the V-grooves 11, or between the optical fibers 12 and the upper substrate 14. Thus, it cannot be said that the optical fibers 12 are maintained sufficiently fixed. In the case of FIG. 7 in which the diameter of the circle inscribed into the V-grooves is greater than the diameter of the optical fibers, the layer of adhesive 16 of the planar portions 13a and 14a is lost entirely lost, so it could not be said that the substrates were sufficiently adhered to one another.

Describing in more detail the reason why the layer of adhesive 16 is lost, a predetermined load is normally applied to the substrates to adhere and fix them to one another to secure dimensional precision between the substrates. Adhesive is viscosity but low viscosity adhesive is used so that the substrates are adhered and fixed without generating bubbles, for example, because the region of the optical fiber fixing portion is extremely narrow. Thus, even if sufficient adhesive is added so that the substrates are joined together in floating condition in the V-groove, the adhesive is pushed out with the weight applied during adhesion. Ultimately an adhesive layer that is less than 1 μm and close to 0 μm is formed between the substrates, or between the substrates and the optical fiber.

Then, when the adhesive is cured in this state, adhesive layers near 0 μm have a poor adhesive ability, or the curing shrinkage of the adhesive may cause cavities in the adhesive layer. Thus, it was difficult to obtain sufficient reliability.

Consequently, adhesive layers of a certain thickness is required between those planar portions, or between the substrates and the optical fibers. However, it was difficult to accurately produce that thickness using an adhesive with low viscosity.

### DISCLOSURE OF THE INVENTION

An optical fiber array according to the present invention includes optical fibers arranged in V-grooves formed in the upper surface of a lower substrate, an upper substrate that covers the lower substrate and the optical fibers, and the lower substrate, the optical fibers, and the upper substrate are fixed to one another by an adhesive, wherein the diameter of the optical fibers is smaller than the diameter of an inscribed circle that is formed between a bottom surface of the upper substrate and the V-grooves, and a distance between the opposing planes of the lower substrate and the upper substrate is from 1 μm to substantially one half the diameter of the optical fibers.

If V-grooves of substantially the same shape are formed on the bottom surface of the upper substrate and in positions corresponding to the V-grooves of the lower substrate, the diameter of the optical fibers should be smaller than the diameter of the inscribed circle that is formed between said V-grooves and the V-grooves of the lower substrate. In either case, the diameter of the optical fibers arranged in the V-grooves should be 97.0% to 99.9% of the diameter of the inscribed circle.

With the above configuration, as the thickness of the adhesive between the substrates is at least 1 μm, cavities do not occur during adhesive curing, and a good adhesion between the substrates can be maintained. Further, the optical fibers can be easily arranged in a line within the V-grooves, because the adhesive is given a thickness that is not more than half the diameter of the optical fibers and the adhesive adjusts the cores of the optical fibers.

Also, an adhesive layer can be formed between the optical fibers and the V-grooves, and the occurrence of stress concentrations on the optical fibers at the end of the V-grooves can be eliminated with the adhesive layer as a cushion.

In particular, if the diameter of the optical fibers is greater than the diameter of the inscribed circle formed between the V-grooves formed in the lower substrate and the virtual plane joining the upper surface of the lower substrate, then the desired adhesive thickness can be easily secured.

A method of fabricating an optical fiber array according to the present invention, wherein the optical fiber array has optical fibers arranged in V-grooves formed in the upper surface of a lower substrate, an upper substrate that covers the lower substrate and the optical fibers, and in which the lower substrate, the optical fibers, and the upper substrate are fixed by a UV curing adhesive, the method of fabricating the optical fiber array includes an embedding step, wherein optical fibers are embedded in the V-grooves in which there is an adhesive with a viscosity of 3000 cp or less, or wherein an adhesive with said viscosity is filled into the V-grooves after the optical fibers have been placed into the V-grooves; a viscosity adjustment step, wherein the viscosity of the adhesive is increased by UV irradiation; and a curing step, wherein after the upper substrate is pushed on the lower substrate with a certain load, UV rays are irradiated to cure the adhesive, and the lower substrate, the optical fibers, and the upper substrate are completely joined to one another.

According to this method, because the viscosity adjustment step is provided to increase the viscosity of the adhesive before the upper substrate is mounted and pressed, the thickness of the adhesive between the upper and lower substrates can be easily set to at least 1 μm. Thus, the occurrence of cavities during curing is eliminated. With this simple method, a good adherence between the lower substrate and the upper substrate can be obtained, and weather-resistance can be improved. Moreover, as the adhesive is subject to initial shrinkage with the first UV irradiation, shrinkage stress after curing is reduced and a good state of adhesion can be maintained.

Furthermore, because the initial low-viscosity adhesive adjusts the core of the optical fibers, it is possible to ensure that the optical fibers are precisely positioned, and the adhesive layer between the substrates and the optical fibers can be secured. As a result, the concentration of stress on the optical fibers can be prevented.

Also, if the above method further includes an optical adjustment step of adjusting the angle of the polarization maintaining fibers, which is carried out between the viscosity adjustment step and the curing step, then an optical fiber array in which the polarization angle is adjusted can be easily produced, even if the optical fibers are polarization maintaining fibers.

### BRIEF DESCRIPTION OF THE DRAWINGS

FIG. 1 is a magnified front view of an optical fiber array.

FIG. 2 is a magnified front view showing another embodiment of an optical fiber array.

FIG. 3 is a magnified front view showing another embodiment of an optical fiber array.

FIG. 4 is a magnified front view showing another embodiment of an optical fiber array.

FIG. 5 is a magnified front view of a conventional optical fiber array.

FIG. 6 is a lateral view of the optical fiber array of FIG. 5.

FIG. 7 is a magnified front view showing another example of a conventional optical fiber array.

1 . . . optical fiber; 2 . . . lower substrate; 3 . . . V-groove; 4 . . . upper substrate; 5 . . . adhesive; A . . . inscribed circle formed between the V-grooves of the lower substrate and the virtual plane of the upper surface of the lower substrate; B. . . inscribed circle formed between the lower wall of the uppers substrate and the V-grooves of the lower substrate.

### BEST MODE FOR CARRYING OUT THE INVENTION

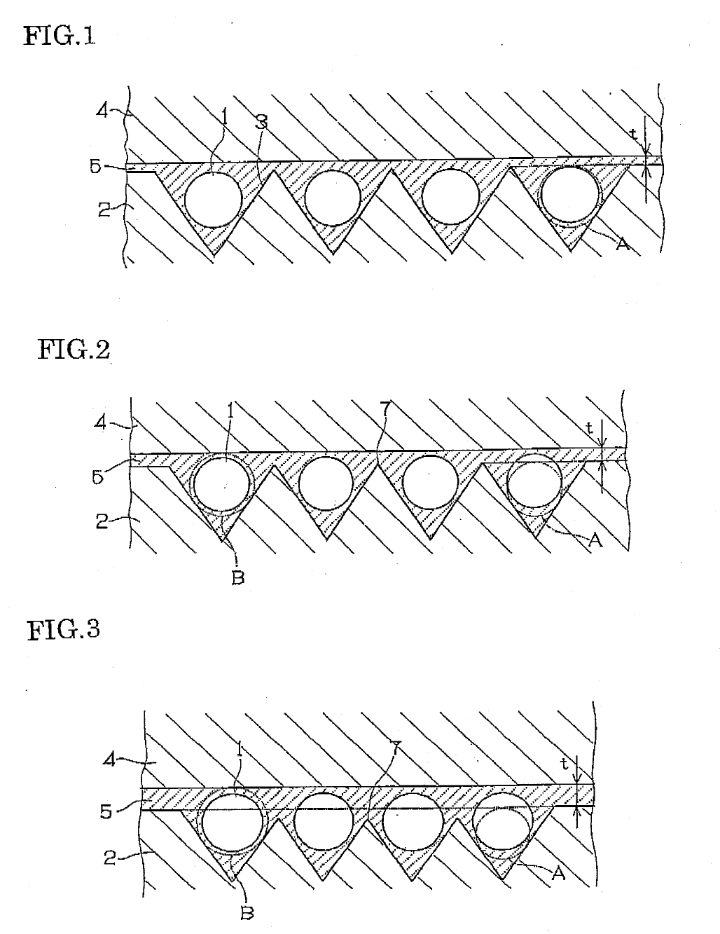

A specific embodiment of the present invention is described below with reference to the drawings. FIG. 1 is a cross-sectional diagram showing an example of an optical fiber array according to the present invention. Optical fibers 1 are arranged within V-grooves 3 formed in a lower substrate 2. The upper portion of the optical fibers 1 is pushed in and held by an upper substrate 4, and a UV curing adhesive 5 is filled into the space between the lower and upper substrates 2, 4, and is also filled into the space between the optical fibers 1 to adhesively fix them to one another.

The lower substrate 2 and the upper substrate 4 are made of a non-metallic, inorganic material such as ceramic or glass, or of engineering plastic, which is dimensionally and thermally stable. In the lower substrate 2, a plurality of V-grooves 3 are formed to be adjacent to one another in a linear arrangement at predetermined opening angles of 70°, matching the number of optical fibers to be accommodated. Furthermore, the diameter of an inscribed circle A formed between the V-grooves and the virtual plane of the upper surface of the lower substrate is made greater than the diameter of the optical fibers 1 contained in the V-grooves, so that the optical fibers 1 are entirely accommodated.

Moreover, the upper substrate 4 has a flat bottom surface that is adhered to the lower substrate 2 and the top of the optical fibers 1, holding the optical fibers. The space between the lower substrate 2 and the upper substrate 4, and the gaps between the optical fibers 1 and the lower and upper substrates 2, 4, are filled in with the UV curing adhesive 5, without leaving any gaps, so that the optical fibers and the substrates are adhered to one another via an adhesive layer. The thickness t of the adhesive layer between the lower substrate 2 and the upper substrate 4 is formed to 8 μm, for example. An adhesive thickness of this extent can be easily formed by the production method explained later. It is preferable that the thickness t of the adhesive layer between the lower substrate 2 and the upper substrate 4 is at least 1 μm, so that cavities do not occur after the adhesive is cured.

Thus, the cores of the optical fibers are centered in the V-grooves by the adhesive. Further, the optical fibers are precisely arranged within the V-grooves, an adhesive layer of at least 1 μm can be formed between the optical fibers and the V-grooves. As a result, good adhesion can be obtained without creating cavities.

Next follows a description of the procedure for producing the above-described optical fiber array. First, the optical fibers 1 are arranged in the V-grooves 3 in the bottom substrate 2, and a UV curing adhesive with a low viscosity of 2000 cp for example, at which bubbles do not occur, is filled into the V-grooves 3. Regarding the order of filing in the adhesive at this time, the adhesive can be filled in after the optical fibers 1 have been accommodated in the V-grooves 3, or the adhesive can be filled in the V-grooves 3 first before arranging the optical fibers 1 in the V-grooves 3. In either case, the adhesive is filled into the gaps between the V-grooves 3 and the optical fibers 1, and the optical fibers 1 can be arranged in a line at predetermined positions within the V-grooves 3, due to the core adjustment effect of the adhesive.

Then, a predetermined amount of UV light is irradiated to appropriately increase the viscosity of the adhesive. After this increase, the viscosity should be in excess of 3000 cp, for example. After the upper substrate 4 is mounted, a certain pressure is applied to the adhesive to cause it to adhere securely, and extra adhesive is discharged to the periphery. Thus, with that increase in viscosity, a uniform adhesive thickness t between the upper and lower substrates is easily secured within a range of about 1 to 10 μm. As a result, the adhesive layer can be set to a constant desired thickness without becoming 1 μm or less, and it can be ensured that the adhesive layer between the optical fibers 1 and the upper and lower substrates is at least 1 μm thick. Furthermore, even if the viscosity increases like this, the adhesive does not completely cure and the optical fibers 1 can still be rotated. Thus, if the optical fibers 1 are polarization maintaining fibers, their optical angle can be adjusted after the viscosity increases.

Then, once the necessary adjustments are finished, UV light is irradiated again to completely cure the adhesive, and the procedure is completed. To illustrate one example of the adhesive, using an epoxy adhesive with a viscosity of 2000 cp, a curing shrinkage of 2%, and a necessary energy for complete curing of 5000 mJ/cm², it was possible to raise the viscosity to an appropriate degree by irradiating 50 mJ/cm² of energy in the initial curing.

Thus, because the viscosity of the adhesive is raised by a viscosity adjustment step in which UV rays are irradiated after the optical fibers 1 have been arranged in the V-grooves 3, the cores of optical fibers 1 in the adhesive can be adjusted in a precise position for the optical fibers 1, while it still has an initial low viscosity. Moreover, an optical fiber having a good adhesive layer is easily formed by the simple method of adhering the upper substrate 4 to the lower substrate 2 with a predetermined pressure. Also, as the adhesive material initially shrinks with the first UV irradiation, there is less shrinkage after the complete curing and little shrinkage stress after adhesion. Thus, a good adhesive state can be maintained, and weather-resistance is increased.

Furthermore, if the optical fibers 1 are polarization maintaining fibers, the circumference of the optical fibers is protected by the adhesive in the V-grooves 3, and they are not supported in direct contact with the substrates after they are arranged. Thus, the adhesive works as a cushion so that no stress is applied in a certain direction, and the polarization properties of the fibers are not degraded. Consequently, the task of optical adjustment for adjusting the polarization angle can be easily carried out.

FIG. 2 and FIG. 3 show other examples of optical fiber arrays according to the present invention. Both show a case in which the diameter of the optical fibers 1 is larger than the diameter of the inscribed circle A of the V-grooves 3. FIG. 2 shows a case in which peaks 7 between adjacent V-grooves are in the same plane as the substrate. FIG. 3 shows a case in which the peaks 7 are formed lower than the plane of the substrate. It should be noted that B indicates the inscribed circle formed between the lower surface of the upper substrate 4 and the V-grooves 3 of the lower substrate 2.

As mentioned above, good adhesiveness can be obtained if the adhesive thickness t between the upper substrate 4 and the lower substrate 2 is at least 1 μm. However, from the standpoint of optical fiber reliability, the adhesive thickness t is ideally 5 μm to 40 μm. For this, as shown in FIG. 2 and FIG. 3, it is easy to ensure the desired adhesive thickness t by making the diameter of the optical fibers larger than the diameter of the inscribed circle A, which is formed between the V-grooves of the lower substrate 2 and the virtual plane of the upper surface of the lower substrate. For example, if the adhesive thickness t is set to 30 μm, then, when the adhesive layer at the circumference of the optical fibers is 1 μm, the relationship of the inscribed circle A to the diameter of the optical fibers can be set so that the gap between the upper and lower substrates obtained by directly abutting the optical fibers against the V-grooves becomes 28 μm. Then, it is easy to secure a 1 μm thick adhesive layer at the circumference of the optical fibers by filling in the adhesive and completing the viscosity adjustment step by UV irradiation. As a result, the total of 30 μm can be easily obtained by adding the adhesive layers of 1 μm thickness above and below the optical fiber to the 28 μm mentioned above.

It is preferable that the diameter of the optical fibers 1 is formed such that it is 97.0% to 99.9%, and most preferably 99.0% of the diameter of the inscribed circle B that is formed between the lower surface of the upper substrate 4 and the V-grooves 3 of the lower substrate 2. Furthermore, if the diameter of the optical fibers is for example 125 μm, then the adhesive thickness t between the upper and lower substrates should be at most one half of that, that is about 62.5 μm. This is because the core adjusting effect of the adhesive can still be attained at this thickness.

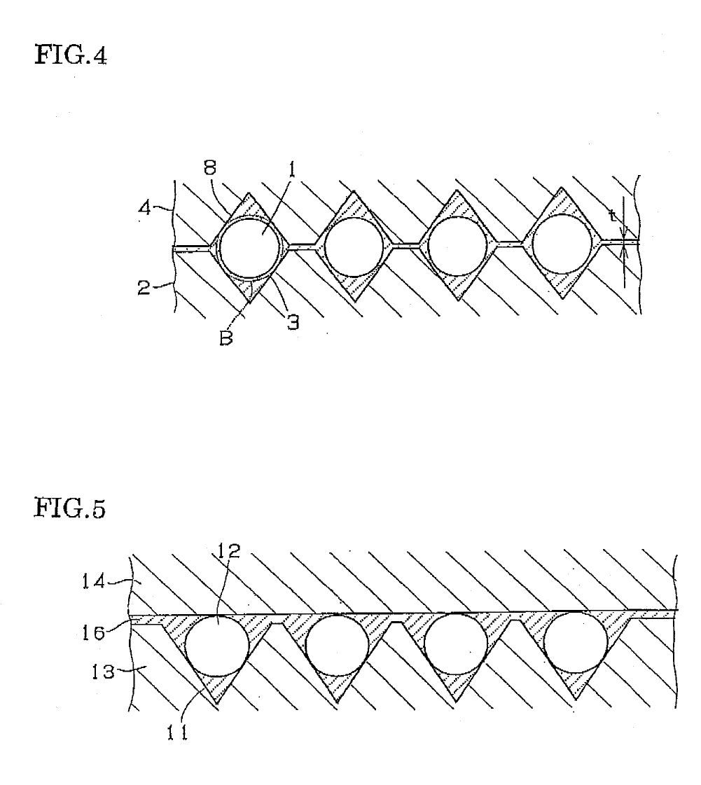

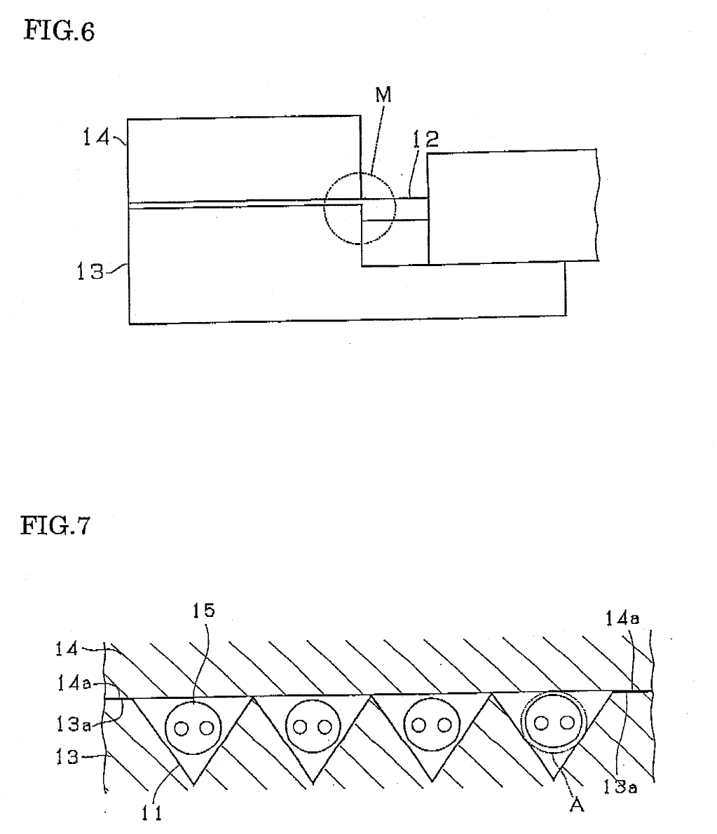

Furthermore, the optical fibers can be polarization maintaining fibers in all of these configurations, since optical adjustment is easy because of an adhesive layer around the optical fibers. As shown in FIG. 4, V-grooves 8 can be provided in the fastening surface of the upper substrate 4 in the same way as in the lower substrate 2 so that the V-grooves 8 grasp the optical fibers 1. In this case, the adhesive thickness t can be secured and easily set to 10 μm, for example.

1. An optical fiber array, in which optical fibers are arranged in V-grooves that are formed in an upper surface of a lower substrate, an upper substrate covers the lower substrate and the optical fibers, and the lower substrate, the optical fibers, and the upper substrate are fastened to one another by an adhesive,
wherein the diameter of the optical fibers is smaller than the diameter of an inscribed circle that is formed between a bottom surface of the upper substrate and the V-grooves; and
a distance between opposing planes of the lower substrate and the upper substrate is from 1 μm to substantially one half the diameter of the optical fibers.

2. The optical fiber array according to claim 1, wherein the bottom surface of the upper substrate has V-grooves of substantially the same shape and in positions corresponding to the V-grooves of the lower substrate, and the diameter of the optical fibers is smaller than the diameter of an inscribed circle that is formed between said V-grooves of the upper substrate and the V-grooves of the lower substrate.

3. The optical fiber array according to claim 1 or claim 2, wherein the, diameter of the optical fibers arranged in the V-grooves is 97.0% to 99.9% of the diameter of the inscribed circle.

4. The optical fiber array according to claim 1, wherein the diameter of the optical fibers is greater than the diameter of an inscribed circle that is formed between the V-grooves in the lower substrate and a virtual plane joining the upper surface of the lower substrate.

5. A method of fabricating an optical fiber array, the optical fiber array having optical fibers arranged in V-grooves that are formed in an upper surface of a lower substrate, an upper substrate that covers the lower substrate and the optical fibers, and in which the lower substrate, the optical fibers, and the upper substrate are fixed by a UV curing adhesive, comprising:
an embedding step, wherein optical fibers are embedded in the V-grooves in which there is an adhesive with a viscosity of 3000 cp or less, or wherein an adhesive with said viscosity is filled into the V-grooves after the optical fibers have been placed into the V-grooves;
a viscosity adjustment step, wherein the viscosity of the adhesive is increased by UV irradiation; and
a curing step, wherein after the upper substrate is pushed on the lower substrate with a certain load, UV rays are irradiated to cure the adhesive, and the lower substrate, the optical fibers, and the upper substrate are completely joined to one another.

6. The method of fabricating an optical fiber array according to claim 5, wherein the optical fibers are polarization maintaining fibers, and the method further comprising an optical adjustment step of adjusting an angle of the polarization maintaining fibers, which is carried out between the viscosity adjustment step and the curing step.
